(19) United States
(12) Patent Application Publication
(10) Pub. No.: US 2025/0363817 A1
(43) Pub. Date: Nov. 27, 2025

(54) SYSTEMS AND METHODS FOR ACCESSIBLE IMAGE CAPTIONING AND NAVIGATION

(71) Applicants: Stephanie Willcox, Moline, IL (US); David Hanan, Moline, IL (US)

(72) Inventors: Stephanie Willcox, Moline, IL (US); David Hanan, Moline, IL (US)

(21) Appl. No.: 18/673,420

(22) Filed: May 24, 2024

(51) Int. Cl. G06V 20/70; G06T 5/50; G06T 7/11; G06T 19/00

(52) U.S. Cl. CPC G06V 20/70; G06T 5/50; G06T 7/11; G06T 19/003; G06T 2207/20221

(57) ABSTRACT

Methods, systems and computer readable media for accessible image captioning and navigation, are described.

### TECHNICAL FIELD

Embodiments relate generally to computer systems for virtual tours, and more particularly, to methods, systems and computer readable media for accessible image captioning and navigation, including an application for experiencing 360° 3D panoramic environments and objects.

### BACKGROUND

Computer users with a visual or other impairment may experience considerable challenges and difficulties when experiencing or accessing online virtual tours or other online visual experiences. Due to the sight impairment, such users may have difficulty navigating online tours or other visual experiences. Further, traditional image captions may be ineffective for such users as traditional image captions may only describe an image or an image file and may not be provided automatically as a user navigates within a virtual tour. Moreover, traditional image captions may not provide navigation information that may be helpful to a user with a sight impairment.

Some implementations were conceived in light of the above-mentioned needs, problems and/or limitations, among other things. The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

### SUMMARY

Some implementations can include a method comprising obtaining an image, dividing the image into a plurality of sections, and generating a calibration map corresponding to the image and the plurality of sections. The method can also include overlaying the calibration map on the image, receiving a caption and a caption parameter for each section, and associating the image, calibration map and captions to generate an accessible image.

The method can further include causing the accessible image to be displayed, receiving an indication of enabling accessibility mode, permitting a user to navigate between sections of the accessible image, wherein the user navigates via selection of a predetermined keyboard key, and when a user navigates to a given section of the accessible image, outputting a caption associated with the given section.

In some implementations, the plurality of sections includes four quadrants. In some implementations, the sections correspond to front, back, left, and right directions relative to an observer of the accessible image. In some implementations, the sections are equirectangular quadrants. In some implementations, the plurality of sections includes sections corresponding to up and down relative to an observer of the accessible image.

In some implementations, the caption includes a description of the section of the image corresponding to the caption. In some implementations, the caption includes navigation information regarding the accessible image. In some implementations, the image includes an image of an interior or exterior scene.

In some implementations, the image includes an image of an object. In some implementations, the sections correspond to respective surfaces of the object. In some implementations, each navigation direction corresponds to one of the object surfaces. In some implementations, navigation inputs from the user cause the object to rotate a different surface into view along with a caption corresponding to that side of the object.

In some implementations, the calibration map includes data providing alignment between the image and each section corresponding to a user's point of view.

Some implementations can include a first-person mode configured for permitting a user to navigate through a 3D environment of one or more images and passing one or more planes of captions at various depths, wherein a proximity to each plane and an orientation caption can be output.

The method can also include presenting the accessible image in an extended Reality (XR) interface or mixed reality interface. The method can further include presenting the accessible image in an augmented reality interface.

The method can also include presenting the accessible image in a virtual 3D environment. In some implementations, the caption information further comprises depth and orientation information corresponding to a 3D image. The method can further include presenting captions provided for objects as a user advances within a virtual 3D environment.

### BRIEF DESCRIPTION OF THE DRAWINGS

FIG. 1 shows a networked computer environment configured for accessible image captioning and navigation in accordance with some implementations.

FIG. 2 is a flowchart showing an example method of accessible image captioning and navigation in accordance with some implementations.

FIG. 3 is a diagram of an example panoramic image in accordance with some implementations.

FIG. 4 is a diagram of an example image sectioned in accordance with some implementations.

FIG. 5 is a diagram of an image with a calibration map in accordance with some implementations.

FIG. 6 is a diagram of an image with sections and interface elements for adding captions and caption parameters in accordance with some implementations.

FIG. 7 is a diagram showing an object image and a section defined within the caption user interface in accordance with some implementations.

FIG. 8 is a diagram showing three dimensional sections in accordance with some implementations.

FIG. 9 is a diagram showing three dimensional sections in accordance with some implementations.

FIG. 10 is a diagram showing caption layers within a three-dimensional image in accordance with some implementations.

FIG. 11 is a diagram of an example computing device configured for accessible image captioning and navigation in accordance with at least one implementation.

### DETAILED DESCRIPTION

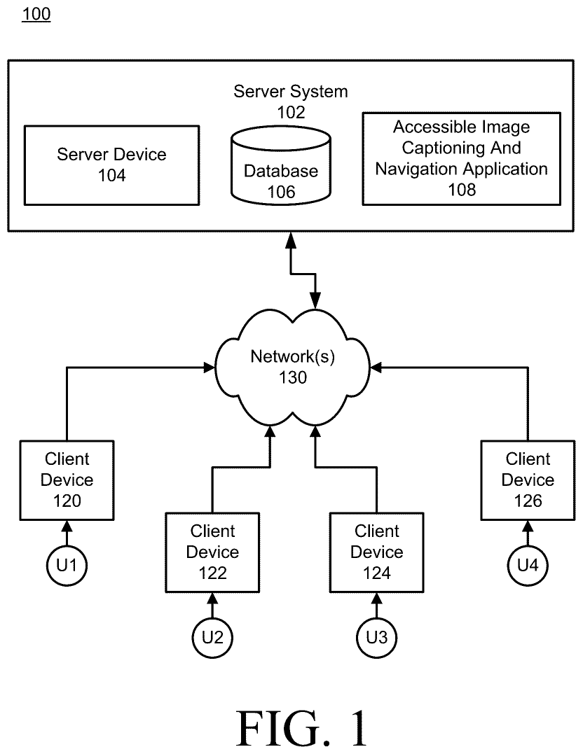

FIG. 1 illustrates a block diagram of an example network environment 100, which may be used in some implementations described herein. In some implementations, network environment 100 includes one or more server systems, e.g., server system 102 in the example of FIG. 1. Server system 102 can communicate with a network 130, for example. Server system 102 can include a server device 104, a database 106 or other data store or data storage device, and an accessible image captioning and navigation application 108. Network environment 100 also can include one or more client devices, e.g., client devices 120, 122, 124, and 126, which may communicate with each other and/or with server system 102 via network 130. Network 130 can be any type of communication network, including one or more of the Internet, local area networks (LAN), wireless networks, switch or hub connections, etc. In some implementations, network 130 can include peer-to-peer communication 132 between devices, e.g., using peer-to-peer wireless protocols.

For ease of illustration, FIG. 1 shows one block for server system 102, server device 104, and database 106, and shows four blocks for client devices 120, 122, 124, and 126. Some blocks (e.g., 102, 104, and 106) may represent multiple systems, server devices, and network databases, and the blocks can be provided in different configurations than shown. For example, server system 102 can represent multiple server systems that can communicate with other server systems via the network 130. In some examples, database 106 and/or other storage devices can be provided in server system block(s) that are separate from server device 104 and can communicate with server device 104 and other server systems via network 130. Also, there may be any number of client devices. Each client device can be any type of electronic device, e.g., desktop computer, laptop computer, portable or mobile device, camera, cell phone, smart phone, tablet computer, television, TV set top box or entertainment device, wearable devices (e.g., display glasses or goggles, head-mounted display (HMD), wristwatch, headset, armband, jewelry, etc.), virtual reality (VR) and/or augmented reality (AR) enabled devices, personal digital assistant (PDA), media player, game device, etc. Some implementations can be executed on an assistive device or in conjunction with an assistive device coupled to a user computing device. Assistive computing devices can include devices designed to help individuals with disabilities or limitations perform tasks that they might otherwise find challenging. Assistive computing devices can include, but are not limited to:

Screen Readers: Software programs that convert digital text into synthesized speech or braille output, enabling individuals with visual impairments to access and interact with computers, smartphones, and other digital devices.

Screen Magnifiers: Software or hardware tools that enlarge on-screen content, making it easier for individuals with low vision to read text and view graphical elements.

Braille Displays: Refreshable braille displays that connect to computers or mobile devices, converting digital text into braille output, allowing individuals who are blind or visually impaired to read and interact with digital content.

Alternative Keyboards: Keyboards with modified layouts, larger keys, or customizable features to accommodate individuals with physical disabilities or limited dexterity.

Eye-Tracking Devices: Devices that track the movement of a user's eyes to control the cursor on a computer screen, enabling individuals with mobility impairments to navigate and interact with digital interfaces.

Switches: Input devices that allow users to perform actions such as clicking, typing, or navigating by pressing or activating switches using different parts of the body, including hands, feet, or head switches.

Speech Recognition Software: Software programs that convert spoken words into text or commands, enabling individuals with mobility impairments or conditions like repetitive strain injuries to control computers or dictate text hands-free.

Augmentative and Alternative Communication (AAC) Devices: Devices and software applications that facilitate communication for individuals with speech or language impairments, including text-to-speech apps, picture-based communication boards, and dedicated AAC devices.

Adaptive Software: Software applications with customizable settings or accessibility features that accommodate various needs and preferences, such as adjustable font sizes, color contrast options, and keyboard shortcuts.

Smart Home Devices: Voice-controlled smart home assistants and home automation systems that allow individuals with mobility impairments to control household appliances, lights, thermostats, and other devices using voice commands or mobile apps.

Some client devices may also have a local database similar to database 106 or other storage. In other implementations, network environment 100 may not have all of the components shown and/or may have other elements including other types of elements instead of, or in addition to, those described herein.

In various implementations, end-users U1, U2, U3, and U4 may communicate with server system 102 and/or each other using respective client devices 120, 122, 124, and 126. In some examples, users U1, U2, U3, and U4 may interact with each other via applications running on respective client devices and/or server system 102, and/or via a network service, e.g., an image sharing service, a messaging service, a social network service or other type of network service, implemented on server system 102. For example, respective client devices 120, 122, 124, and 126 may communicate data to and from one or more server systems (e.g., server system 102). In some implementations, the server system 102 may provide appropriate data to the client devices such that each client device can receive communicated content or shared content uploaded to the server system 102 and/or network service. In some examples, the users can interact via audio or video conferencing, audio, video, or text chat, or other communication modes or applications. In some examples, the network service can include any system allowing users to perform a variety of communications, form links and associations, upload and post shared content such as images, image compositions (e.g., albums that include one or more images, image collages, videos, etc.), audio data, and other types of content, receive various forms of data, and/or perform socially related functions. For example, the network service can allow a user to send messages to particular or multiple other users, form social links in the form of associations to other users within the network service, group other users in user lists, friends lists, or other user groups, post or send content including text, images, image compositions, audio sequences or recordings, or other types of content for access by designated sets of users of the network service, participate in live video, audio, and/or text videoconferences or chat with other users of the service, etc. In some implementations, a “user” can include one or more programs or virtual entities, as well as persons that interface with the system or network.

A user interface can enable display of images, image compositions, data, and other content as well as communications, privacy settings, notifications, and other data on client devices 120, 122, 124, and 126 (or alternatively on server system 102). Such an interface can be displayed using software on the client device, software on the server device, and/or a combination of client software and server software executing on server device 104, e.g., application software or client software in communication with server system 102. The user interface can be displayed by a display device of a client device or server device, e.g., a display screen, projector, etc. In some implementations, application programs running on a server system can communicate with a client device to receive user input at the client device and to output data such as visual data, audio data, etc. at the client device.

In some implementations, server system 102 and/or one or more client devices 120-126 can provide accessible image captioning and navigation functions as described herein.

In some implementations, the accessible image captioning and navigation system can be executed locally on a device. For example, the accessible image with captioning can be downloaded into the user device and then operated in an offline mode not requiring a connection to a network or other data communication service.

Various implementations of features described herein can use any type of system and/or service. Any type of electronic device can make use of the features described herein. Some implementations can provide one or more features described herein on client or server devices disconnected from or intermittently connected to computer networks.

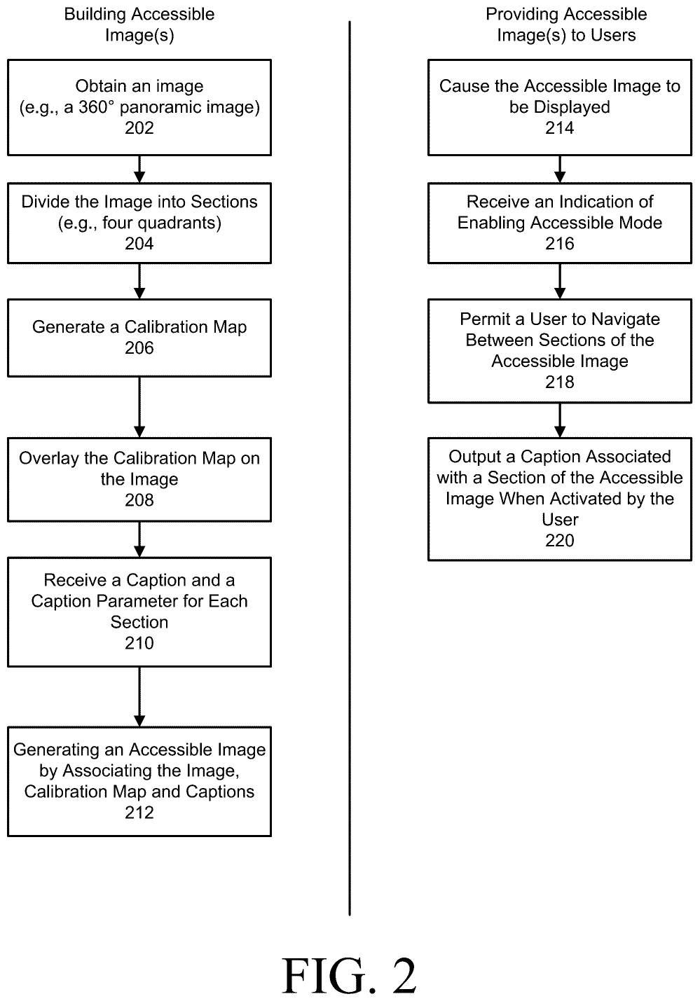

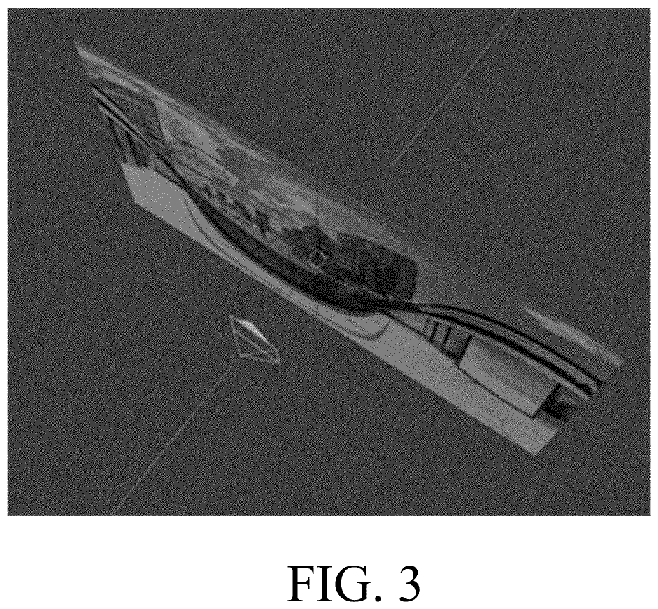

FIG. 2 is a flowchart showing an example method of accessible image captioning and navigation in accordance with some implementations. Processing begins at 202, where an image is obtained. FIG. 3 shows an example image. The image can include a panoramic image such as a 360° image. The image can be obtained by retrieving the image from memory, receiving from an external device, or receiving as part of a media stream. The image can be a still image or a frame of a video, etc. In some implementations, the image can be generated by a 3D environment generation system such as 3D Vista, KR Pano, Unity, CloudPano or now known or later developed software for performing similar 3D environment tasks. Processing continues to 204.

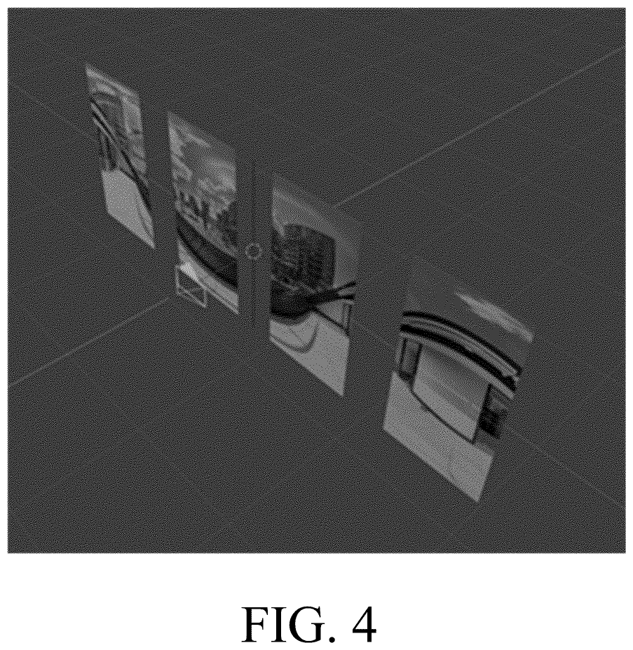

At 204, the image is divided into sections. For example, as shown in FIG. 4, the image can be divided into four quadrants corresponding to front, back, left, and right. In another example, the image can be divided into six sections corresponding to front, back, right, left, top, and bottom. In general, the image can be divided into any suitable number of sections. The sections can be defined by point coordinates or other parameters within the image. Processing continues to 206.

At 206, a calibration map is generated. The calibration map can include a png file (or other image file type), with the quadrants (or sections) colorized and labeled per their orientation (e.g., front, back, left, right). Each calibration map aligns the image (or panorama) and the user's orientation. The quadrant can be traced with a polygon tool, or an icon is placed over the area within the quadrant. Each panorama can have several quadrants (e.g., four without the top and bottom). The quadrant contains the captioning for the area. Quadrants are made invisible in the application—the quadrants are shown in the figures for the purpose of explaining the disclosed subject matter. Processing continues to 208.

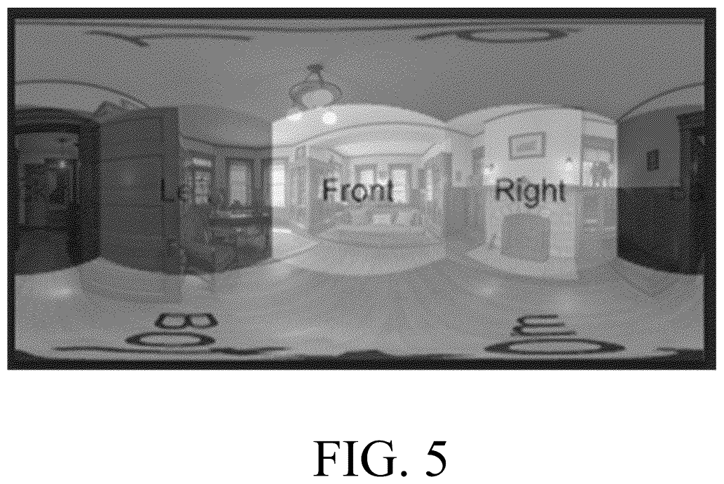

At 208, an overlay based on the calibration map is added to the image. FIG. 5 shows a panoramic image with the calibration map overlay in a visible form for illustration. Processing continues to 210.

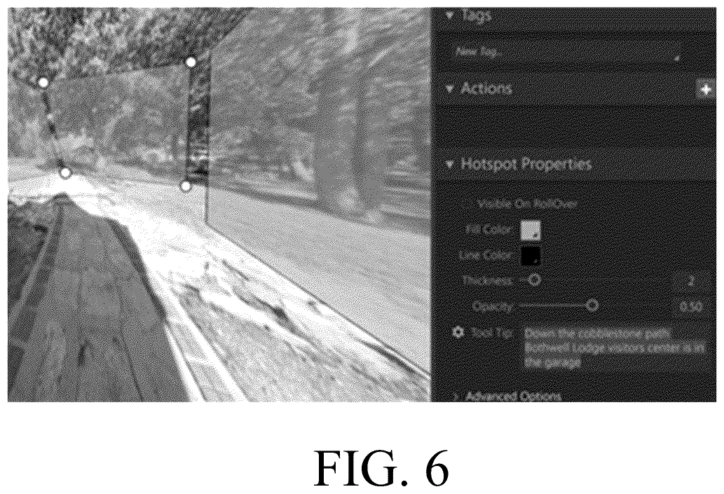

At 210, a caption and a caption parameter are received for each section of the image. For example, as shown in FIG. 6, a section to the front is selected (as shown by white dots) and the caption can be added via the interface on the left of the diagram. The caption information can include one or more of: a description of what the user would be seeing in the selected section, an orientation of the section (e.g., the front), and/or navigation information or other information. The captions given are a description of the scene in the quadrant as it relates to the user (i.e., ahead an uneven cobblestone path) and the navigability of the area. Thus, the user becomes spatially aware of the scene and is able to navigate the space in person from the prompts. The captions also deliver tour content instruction, navigation and information hotspots. (i.e., click to move forward, tab to get more information). The caption can be attributed to a quadrant via an interface mechanism such as a “tool tip.” A user action, such as “on roll over,” “on hover,” or “on focus.” The sections can be given a tab order in which the sections are navigated to based on a tab order. For example, as a user presses the tab key (or provides other input for navigation), the system will navigate the user to sections in the given tab order (e.g., front, right, back, left). Processing continues to 212.

At 212, an accessible image is generated by combining the image, calibration map, and caption data.

The user process begins at 214, where an accessible image is caused to be displayed. Processing continues to 216.

At 216, an indication of enabling accessibility mode is received. When the user has enabled “accessibility mode” a tabbable (i.e., navigable via a predetermined key such as the Tab key). URL on the main viewer can be presented and the captions become visible. Processing continues to 218.

At 218, the user is permitted to navigate within the accessible image (e.g., via the Tab key or any other suitable navigation input method). Processing continues to 220.

At 220, when the user's orientation is aligned with the quadrant (e.g., by rotating to look that direction, or moving a mouse or other pointer over the area) the caption is delivered to the user. It can be done within the software in the use of an audio file, or “text to speech” srt, text, or any suitable format.

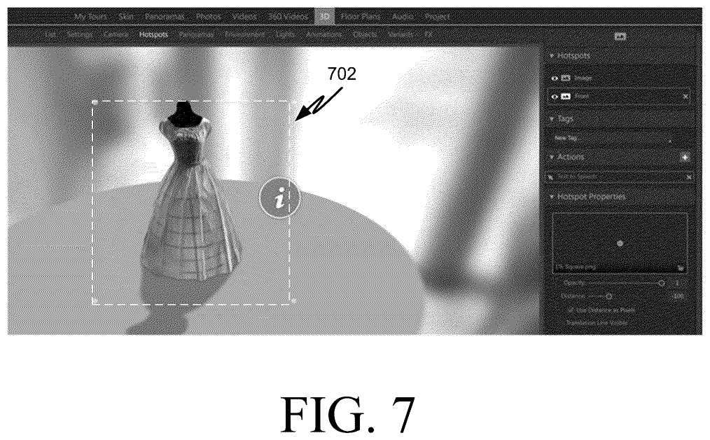

FIG. 7 is a diagram showing an object image and a section defined within the caption user interface in accordance with some implementations. In some implementations, the calibration cube (or map) can be wrapped around an object. As the user turns the object relative to them, the faces of the object are captioned. For example, the 3D object below has a caption description on the front quadrant of the dress. The invisible square 702 has the action on roll over to activate the text to speech function.

Some implementations can include First Person 3D where a user moving through a 3D environment passes planes of captions at various depths to them. The proximity to the plane and the orientation (i.e., within 5 m and ahead) the caption will be read.

Some implementations can include virtual reality in which a user is prompted in a headset on gaze action the description of the scene or object.

Some implementations can include augmented reality, in which the user is delivered a caption based on the face of the object they are projecting.

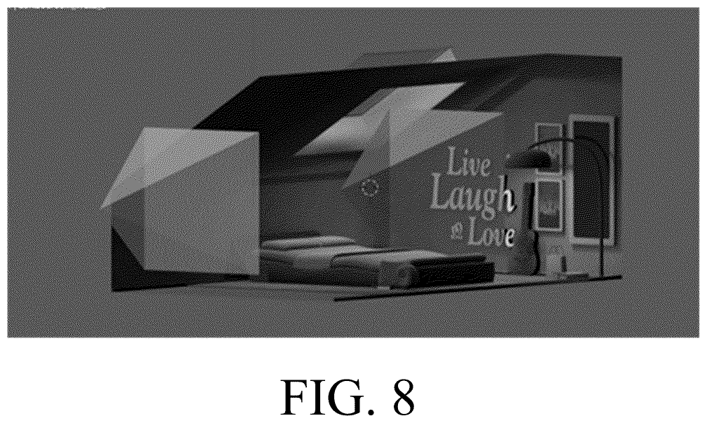

FIG. 8 is a diagram showing three dimensional sections within an example room in accordance with some implementations.

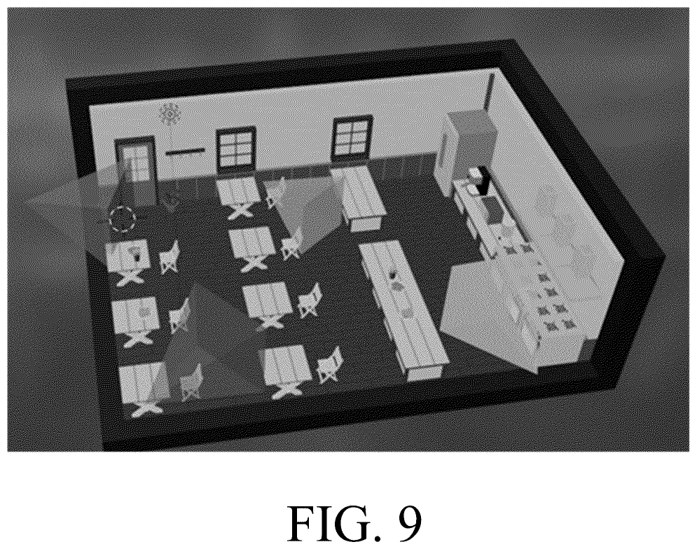

FIG. 9 is a diagram showing another example of three-dimensional sections in a room in accordance with some implementations.

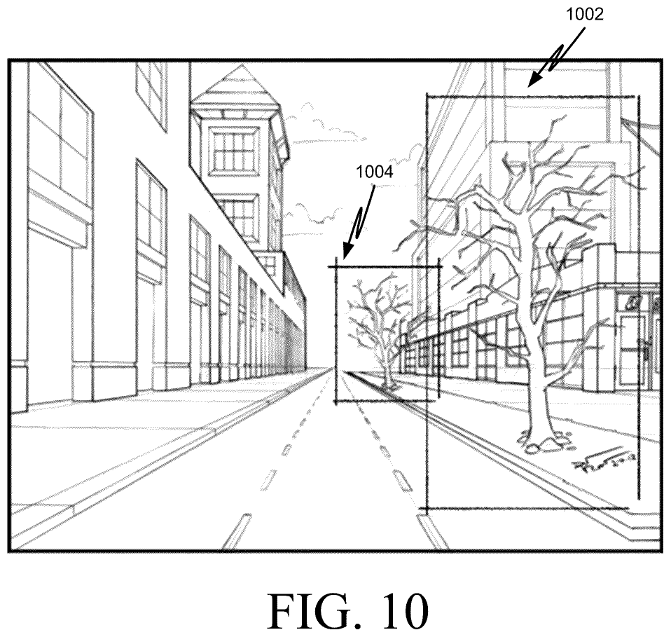

FIG. 10 is a diagram showing caption layers within a three-dimensional image in accordance with some implementations. As a user moves within a given virtual distance of an object such as a first tree 1002, the system can output the caption associated with the tree. Then, as the user continues to navigate forward and comes within a threshold distance of the second tree 1004, the system can output the caption for that tree 1004. Thus, in some implementations, the system can have layers of sections at various distances from the user's current perspective.

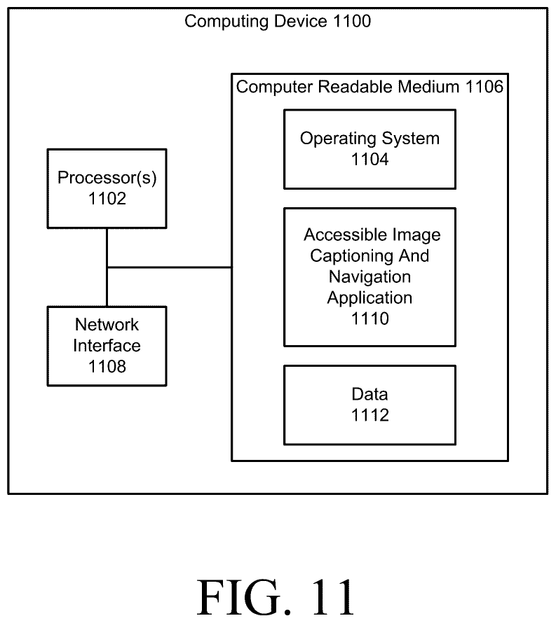

FIG. 11 is a diagram of an example computing device 1100 in accordance with at least one implementation. The computing device 1100 includes one or more processors 1102, nontransitory computer readable medium 1106 and network interface 1108. The computer readable medium 1106 can include an operating system 1104, an application 1110 for accessible image captioning and navigation and a data section 1112 (e.g., for storing images, section data, calibration map data, captions, caption parameters, etc.).

In operation, the processor 1102 may execute the application 1110 stored in the computer readable medium 1106. The application 1110 can include software instructions that, when executed by the processor, cause the processor to perform operations for accessible image captioning and navigation in accordance with the present disclosure (e.g., performing associated functions described above and shown in FIG. 2).

The application program 1110 can operate in conjunction with the data section 1112 and the operating system 1104.

It will be appreciated that the modules, processes, systems, and sections described above can be implemented in hardware, hardware programmed by software, software instructions stored on a nontransitory computer readable medium or a combination of the above. A system as described above, for example, can include a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C, C++, C #.net, assembly or the like. The instructions can also comprise code and data objects provided in accordance with, for example, the Visual Basic™ language, or another structured or object-oriented programming language. The sequence of programmed instructions, or programmable logic device configuration software, and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the software engineering and computer networking arts.

Moreover, embodiments of the disclosed method, system, and computer readable media (or computer program product) can be implemented in software executed on a programmed general-purpose computer, a special purpose computer, a microprocessor, a network server or switch, or the like.

It is, therefore, apparent that there is provided, in accordance with the various embodiments disclosed herein, methods, systems and computer readable media for accessible image captioning and navigation.

While the disclosed subject matter has been described in conjunction with a number of embodiments, it is evident that many alternatives, modifications and variations would be, or are, apparent to those of ordinary skill in the applicable arts. Accordingly, Applicants intend to embrace all such alternatives, modifications, equivalents and variations that are within the spirit and scope of the disclosed subject matter.

What is claimed is:

1. A method comprising:
obtaining an image;
dividing the image into a plurality of sections;
generating a calibration map corresponding to the image and the plurality of sections;
overlaying the calibration map on the image;
receiving a caption and a caption parameter for each section; and
associating the image, calibration map and captions to generate an accessible image.

2. The method of claim 1, further comprising:
causing the accessible image to be displayed;
receiving an indication of enabling accessibility mode;
permitting a user to navigate between sections of the accessible image, wherein the user navigates via selection of a predetermined keyboard key; and
when a user navigates to a given section of the accessible image, outputting a caption associated with the given section.

3. The method of claim 1, wherein the plurality of sections includes four quadrants.

4. The method of claim 1, wherein the sections correspond to front, back, left, and right directions relative to an observer of the accessible image.

5. The method of claim 1, wherein the sections are quadrants on an equirectangular 360 degree panoramic image.

6. The method of claim 1, wherein the plurality of sections includes sections corresponding to up and down relative to an observer of the accessible image.

7. The method of claim 1, wherein the caption can include a description of the section of the image corresponding to the caption.

8. The method of claim 1, wherein the caption includes navigation information regarding the accessible image.

9. The method of claim 1, wherein the image includes an image of an interior or exterior scene.

10. The method of claim 1, wherein the image includes an image of a three-dimensional object.

11. The method of claim 10, wherein the sections correspond to respective surfaces of the object.

12. The method of claim 11, wherein each navigation direction corresponds to one of the object surfaces.

13. The method of claim 12, wherein navigation inputs from the user cause the object to rotate a different surface into view along with a caption corresponding to that side of the object.

14. The method of claim 1, wherein the calibration map includes data providing alignment between the image and each section corresponding to a user's point of view.

15. The method of claim 1, further comprising a first-person mode configured for permitting a user to navigate through a 3D environment of one or more images and passing one or more planes of captions at various depths, wherein a proximity to each plane and an orientation caption can be output.

16. The method of claim 1, further comprising presenting the accessible image in a virtual reality interface.

17. The method of claim 1, further comprising presenting the accessible image in an extended Reality (XR) interface or mixed reality interface.

18. The method of claim 1, further comprising presenting the accessible image in a virtual 3D environment.

19. The method of claim 1, wherein the caption information further comprises depth and orientation information corresponding to a 3D image.

20. The method of claim 1, further comprising presenting captions provided for objects as a user advances within a virtual 3D environment.
